(19) United States
(12) Patent Application Publication
(10) Pub. No.: US 2008/0174571 A1
(43) Pub. Date: Jul. 24, 2008

(54) Pen-Type Input Device with Remote Control

(76) Inventor: HAD-WEN CHEN, Taipei (TW)

Correspondence Address: RABIN & Berdo, PC, 1101 14TH STREET, NW, SUITE 500, WASHINGTON, DC, 20005, US

(21) Appl. No.: 11/625,885

(22) Filed: Jan. 23, 2007

(51) Int. Cl. G06F 3/033

(52) U.S. Cl. 345/179

(57) ABSTRACT

The pen-type input device with remote control is to perform the identified configuration wirelessly, and comprise a main body, a cursor controller, a position sensor, an identified unit, an emitter, and a controller including a circuit board and a main processing unit, and the units are installed in the main body which is a hollow tube. Besides, the input device further includes a rechargeable battery.

### FIELD OF THE INVENTION

The present invention relates to an input device, and more particularly, to a pen-type input device with remote control, which is able to perform the identified configuration wirelessly.

### BACKGROUND OF THE INVENTION

A mouse is an important input device of computers and can be roughly divided into a mechanical type and an optical type based on the detecting way of the movement of cursor. A regular mechanical mouse includes a ball in the bottom side. When moving the mechanical mouse on a plane, the moving directions are transformed into two vertical vectors, and the vectors are detected by a sensor to control the movement of cursor. In addition, a regular optical mouse obtains moving vectors to indicate directions and amounts of movement by recognizing changes of surface image below the mouse.

The conventional mechanical and optical mice mentioned above have similar outer appearances. In order to comply with ergonomics to facilitate manipulation of users, the outer appearances evolved from rectangular shapes, and pen-type mice emerge. U.S. Pub No. 2004/0032392 A1 published on Feb. 19, 2004, titled “Mouse Pen Device Having Remote-Control Function” disclosed a pen-shaped mouse comprising an optical detection unit, a control unit, an operation unit and a wireless emission unit. The optical detection unit is used to emit light and receive the reflected light signal so as to detect the motion of the mouse. Whether the control unit operates in the mouse mode or the remote-controller mode is based on the intensity of the reflected light signal. The operation unit provides corresponding key definitions of mouse and remote controller. The wireless emission unit is used to emit the signal processed by the control unit. Thereby, an operational mode of mouse is achieved when the mouse pen is pressed close to the desk in use, while an operational mode of remote controller is achieved when the mouse pen stands off the desk in use.

U.S. Pat. No. 7,098,894 B2 published on Aug. 29, 2006, titled “Pen Type Optical Mouse Device and Method of Controlling the Same” disclosed a mouse device indicating a cursor position or inputs writing or a movement of the pen-type optical mouse. An aspect of the pen-type optical mouse is to calculate coordinate values of the mouse device in accordance with a movement of the pen-type optical mouse device. The pen-type optical device includes an image sensor on a side of the interior of a main body of pen-type the mouse device, thereby allowing the pen-type optical mouse device to be slim and easy to hold.

User interaction with computers continues to increase every day. More and more jobs require individuals to interact with computers and people interact with computers for work. However, the prior arts of pen-like optical pointing device is characterized by its ergonomic pen-like design, then users utilized the pointing device in a manner like holding a pen, and recognize configuration provided rarely. Along with the proliferation of various computing devices for work and entertainment has come the concomitant proliferation of various pointing devices. Accordingly, the prior arts do not provide the function for preventing confidential information inside computers from revealing easily.

### SUMMARY OF THE INVENTION

In accordance with the objectives of the invention, is to provide a pen-type input device with remote control, which associates with an identified unit providing log in and authentic information to keep confidential when logging in a computer or performing a program.

To achieve the objects of the present invention, the pen-type input device with remote control comprises a main body, a cursor controller, a position sensor, an identified unit, an emitter and a controller. The main body includes a front end cap and a tail end cap, and is used to contain other units of the mouse. The cursor controller set in the main body to work for corresponding operations of the cursor in operating system, wherein the cursor controller further comprises at least one button unit and roller.

The position sensor is set in the front end of the main body for detecting moving vectors of the main body of the mouse, and the position sensor further comprises a ball, X,Y-direction contact rollers, X,Y-direction grid wheels, optical emitting elements, and optical receiving elements. The identified unit is adapted to produce identified information needed for operating system. The emitter is a wireless data transmission unit for transmitting information to an external electrical device by utilizing wireless communication technology. The controller includes a circuit board and a main processing element, wherein the circuit board configured with electric units of the mouse, and the information of the identified unit, cursor controller, and position sensor transformed into output information by main processing element.

The electric units, disposed inside the main body, are electrically connected by the circuit board. The information of the controller is transmitted to the electrical device by the emitter. The emitter is adapted to transmit information utilizes wireless communication technologies such as infrared ray, Bluetooth or radio frequency. The identified unit of the present invention is the Radio Frequency Identification (RFID) of the emitter, to produce log in and authentic information, and transmit the information to the electrical device.

The main body is a hollow tube so that the units of the mouse could be set in the main body, and the main body includes a front end cap and a tail end cap, wherein the front end cap is an inverted cone. The position sensor includes a ball, covered by rubber material, indicating the direction and amount of the movement. The ball is put in the front end cap and partially protrudes out of the front end cap to form a structure similar to a ball-point pen.

Besides, the identified unit further comprises a display element and an input element, wherein the display element displaying information related to the identified procedure, and the input element utilized to input information needed to produce authentic and log in information. The display element could be at least one Light Emitting Diode (LED), a Liquid Crystal Display (LCD), or a buzzer to display situations of identification. In addition, the pen-type input device further comprises a light guide disposed at one end adjacent to the tail end cap, and adopted to produce and project a visible light beam out of the tail end cap for pointing something. The light guide includes an illuminated element and an illuminated button, wherein the illuminated element disposed on the top of the main body and the illuminated button disposed on the surface of the main body. The illuminated element is a laser diode. The illuminated element and button are electrically connected with the circuit board, and pressing/releasing the illuminated button respectively corresponding to the on/off state of the illuminated element.

The pen-type input device with remote control further comprises a battery set in the main body, and electrically connected with the circuit board to deliver power to each electric unit of the input device. The battery is a rechargeable battery, and there is an electronic transmitting unit disposed on the circuit board to charge the battery with external power. The electronic transmitting unit includes an electronic transmitting interface externally connected with the electrical device to charge the battery, and the electronic transmitting interface could be an USB interface. When the battery is charged through the USB interface, the information of the identified unit, cursor controller, and position sensor proceeded by controller is transmitted to the connected electrical device at the same time.

### BRIEF DESCRIPTIONS OF THE DRAWINGS

The foregoing aspects, as well as many of the attendant advantages and features of this invention will become more apparent by reference to the following detailed description, when taken in conjunction with the accompanying drawings, wherein:

FIG. 1 illustrates the exploded view of the present invention

FIG. 2 illustrates the block diagram of the present invention

FIG. 3 illustrates the perspective view of the present invention

FIG. 4 illustrates the longitudinal sectional view of the present invention; and

FIG. 5 illustrates the perspective view of the pen-type input device charged by connecting with a computer.

### DETAILED DESCRIPTIONS OF THE PREFERRED EMBODIMENT

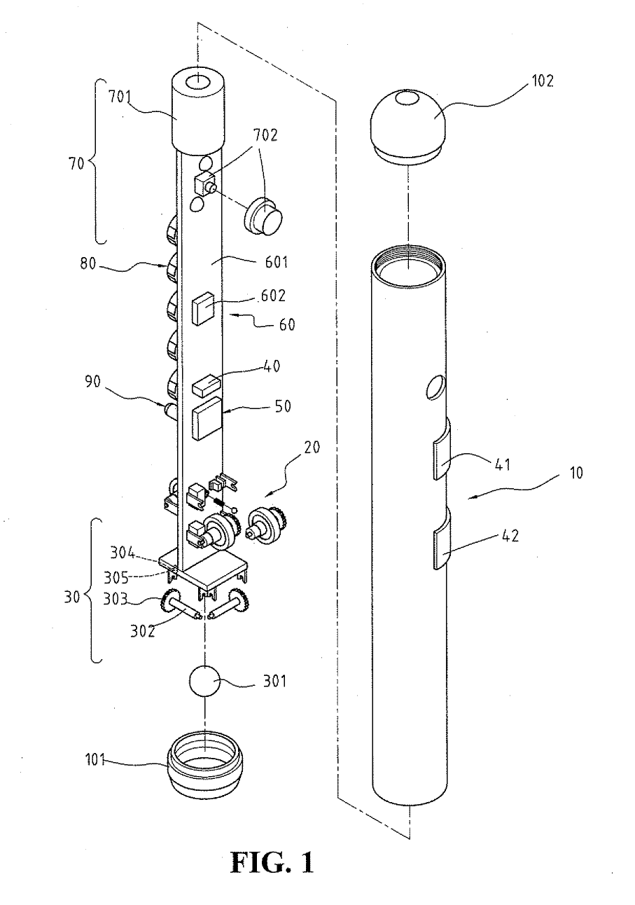

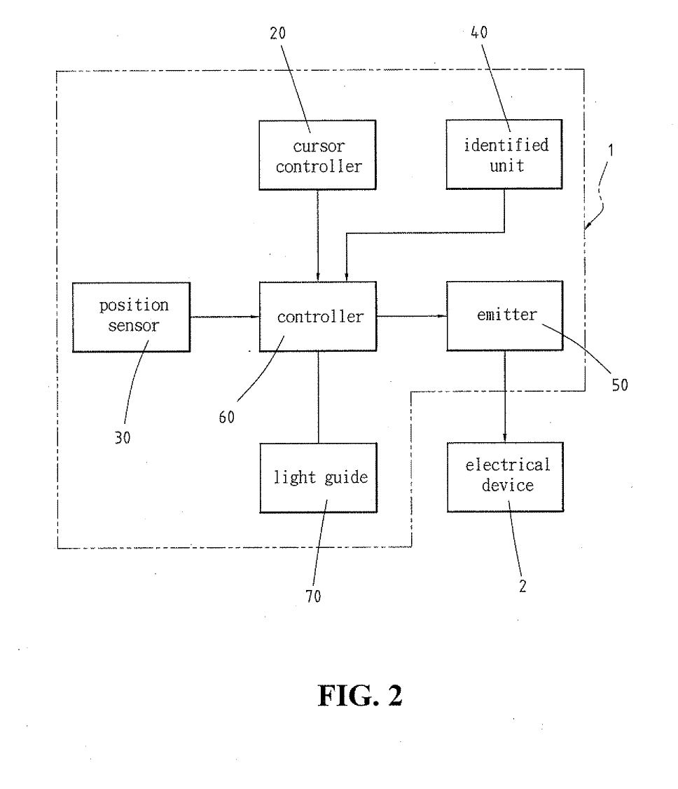

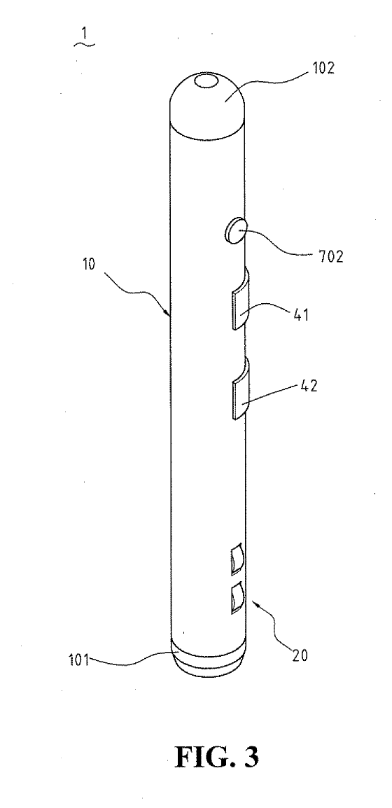

Referring to FIGS. 1, 3, and 4 to illustrate the exploded view, perspective view and the longitudinal sectional view of the pen-type input device 1 with remote control. Next, with reference to FIG. 2 to illustrate the block diagram of the pen-type input device 1, comprising a main body 10, a cursor controller 20, a position sensor 30, an identified unit 40, an emitter 50, a controller 60 and light guide 70.

The main body 10 could be a hollow tube and having a front end cap 101 and a tail end cap 102, wherein the both caps are threaded into both end of the main body 10. The front end cap 101 is an inverted cone so that the position sensor 30 could be set between the front end cap 101 and the circuit board 601. Furthermore, the main body 10 could be pen-type and any hollow structure complying with ergonomics to facilitate manipulation. In the preferred embodiment, the main body 10 and the front end cap 101 are put together to form a structure similar to a ball-point pen for easy usage.

The main body 10 is shaped to comply with ergonomics and the units of the input device 1 installed in the main body 10. The cursor controller 20, set in the main body 10, is installed for corresponding operations of the cursor in operating system, and further comprises at least one button unit 201 and roller 202 which are used to select the functions of operating system.

The position sensor 30 is utilized to detect moving vectors of the main body 10 of the input device 1 for controlling the movement of the cursor in the window, which further comprises a ball, X, Y-direction contact rollers, X, Y-direction grid wheels, optical emitting elements, and optical receiving elements. Moreover, the ball 301 of the position sensor 30, covered by rubber materials, is rolled by moving the input device 1 across a surface when the pen-type input device 1 is utilized. At the same time, users can press the button unit 201 of the cursor controller 20 to produce corresponding operations of the cursor in operating system in accordance with their manipulation demands.

The identified unit 40 is adapted to produce authentic information and log in information needed for operating system. The emitter 50 is a wireless data transmission unit utilized to transmit the information of cursor controller 20, position sensor 30 and identified unit 40 to the electrical device, and the emitter 50 is adapted to transmit the above information to the electrical device by utilizing wireless communication technologies such as infrared ray, Bluetooth or radio frequency. The controller 60 includes a circuit board 601 and a main processing unit 602, wherein the circuit board 601 configured with the electric units of the input device 1, and the information of the cursor controller 20, position sensor 30 and identified unit 40 transformed into output information by the main processing unit 602. The output information is transmitted to the electrical device through the emitter 50.

The object of the present invention is to provide a recognized function by the log in and authentic information, needed for operating system, the information related with an authentic ID and password verifying to startup or perform a program. In addition, the identified unit 40 is the Radio Frequency Identification (RFID) of the emitter 50, and the log in and authentic information is transmitted to the electrical device directly by the identified unit 40 of the emitter 50. Therefore the pen-type input device with remote control could transmit the information of the cursor controller 20, position sensor 30, and identified unit 40 to the electrical device wirelessly through the emitter 50.

In addition, the identified unit 40 produces log in information or authentic information when logging in or authorizing procedure executed, then the information is transmitted to the electrical device by the emitter 50 to finish the identified procedure. The identified unit 40 further comprises a display element 41 and an input element 42, wherein the display element 41 is utilized to display relative information of identified procedure, and the input element 42 is an input interface such as a key, a fingerprint input or a touch panel. The input element 42 is adapted to input relative information to produce log in or authentic information.

In the preferred embodiment, the display element 41 includes at least one Light Emitting Diode (LED). While the identified procedure is proceeding, the LED is radiating to indicate the states of the procedure. Moreover the display element 41 could be a Liquid Crystal Display (LCD) to show some words, graphs and colors to indicate the states of the procedure. Besides, the display element 41 could also be a buzzer, which sounds to indicate the states of identified procedure.

Subsequently, with reference to FIGS. 1, 3, and 4, the pen-type input device 1 further includes a light guide 70 for producing and projecting a visible light beam to provide the pointer function. The light guide 70 further includes an illuminated element 701 and an illuminated button 702, wherein the illuminated element 701 could be a laser diode disposed on the top of the main body 10, and emitting light beam out of the tail end cap 102. The illuminated button 702 is disposed on the surface of main body 10, and is controlled for turning on/off the illuminated element 701. The illuminated element 701 and the illuminated button 702 are electrically connected with the circuit board 601, and pressing/releasing the illuminated button 702 respectively corresponding to the on/off state of the illuminated element 701.

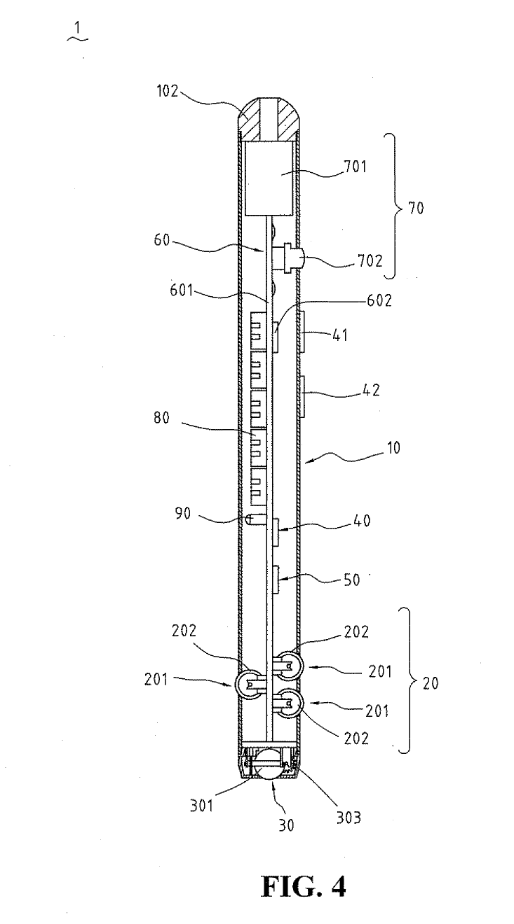

Referring to FIG. 1 and FIG. 4 again, the pen-type input device 1 further comprises a battery 80, electrically connected with the circuit board 601 installed in the main body 10. The battery 80 provides necessary working power to each electric unit of the input device 1 through the circuit board 601, and the battery 80 could be a rechargeable battery such as a Nickel-Metal Hydride battery or lithium battery. Besides, the pen-type input device 1 further comprises an electronic transmitting unit 90 disposed on the circuit board 601 to charge the batteries 80 with external power sources.

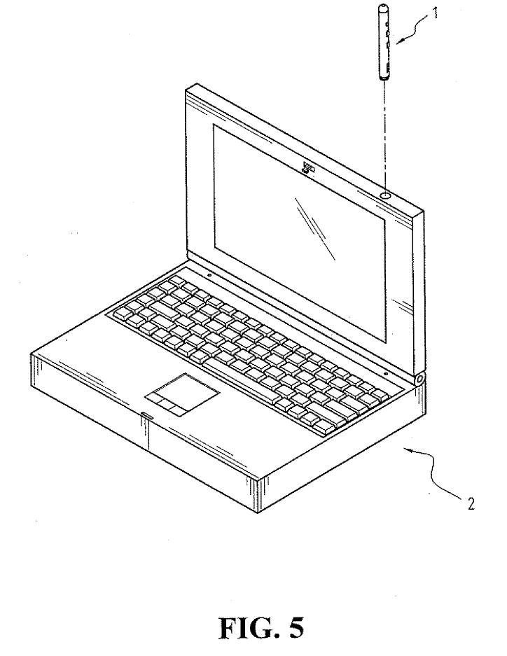

Furthermore, with reference to FIG. 5, illustrating the perspective view of the pen-type input device charged by connecting with a computer, the electronic transmitting unit 90 is set on the circuit board 601, and is electrically connected with the electrical device 2 to charge the battery. Moreover, the transformer utilized by the electrical device 2 could be any electronic transmitting interface such as USB interface. When the battery of the input device 1 is charged through USB interface, the electric information of the input device 1 is also transmitted to the electrical device 2 through the USB interface. Instead of the emitter, the information could be transmitted to the electrical device 2 through the electronic transmitting units while recharging.

To sum up, the pen-type input device with remote control of the present invention provides the following characteristics.

First, the identified unit of the pen-type input device provides the log in and authentic information needed for the identified procedure while logging in a computer or executing a program. The log in and authentic information could be transmitted to a computer wirelessly as well as the information of the cursor controller and position sensor.

Second, the battery of the input device is rechargeable and could be charged through the electronic transmitting interface. Additionally, the information of the cursor controller, position sensor, and identified unit could be transmitted through the electronic transmitting interface to the electrical device while recharging.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A pen-type input device with remote control, comprising:
a main body, including a front end cap and a tail end cap;
a cursor controller, set in the main body;
a position sensor, installed in the front end of the main body for detecting vectors of the main body;
an identified unit, adapted to produce identified information needed for operating system;
an emitter, indicating a wireless data transmission unit; and
a controller, including a circuit board and a main processing element, wherein the circuit board configured with electric units of the input device, and the information of the cursor controller, position sensor, and identified unit transformed into output information by the main processing unit.

2. The pen-type input device of claim 1, wherein the electric units, inside the main body, are electrically connected by the circuit board, and the output information of the controller transmitted to the electric device through the emitter.

3. The pen-type input device of claim 1, wherein the identified unit is the Radio Frequency Identification (RFID) of the emitter, and proposed to transmit the log in and authentic information to the electric device directly.

4. The pen-type input device of claim 1, wherein the identified unit further comprises a display element for displaying information relative to the identified procedure.

5. The pen-type input device of claim 1, wherein the identified unit further comprises an input element for inputting relative information to produce log in and authentic information.

6. The pen-type input device of claim 1, further comprising a light guide for producing and projecting a visible light beam.

7. The pen-type input device of claim 1, further comprising a battery inside the main body, and electrically connected with the circuit board to deliver power to each electric unit.

8. The pen-type input device of claim 1, further comprising an electronic transmitting unit disposed on the circuit board to charge the battery with external power sources.

9. The pen-type input device of claim 1, wherein the emitter is adapted to transmit information wirelessly by utilizing wireless communication technologies such as infrared ray, Bluetooth or radio frequency.

10. The pen-type input device of claim 1, wherein the position sensor includes a ball covered by rubber materials.

11. The pen-type input device of claim 4, wherein the display element is at least one Light Emitting Diode (LED) to display the situation of identification.

12. The pen-type input device of claim 4, wherein the display element is a Liquid Crystal Display (LCD) showing words, graphs or colors to display the situation of identification.

13. The pen-type input device of claim 4, wherein the display element is a buzzer to indicate the situation of identification.

14. The pen-type input device of claim 6, wherein the light guide includes an illuminated element and an illuminated button electrically connected with the circuit board, and pressing/releasing the illuminated button respectively corresponding to the on/off state of the illuminated element.

15. The pen-type input device of claim 7, wherein the battery is a rechargeable battery.

16. The pen-type input device of claim 8, wherein the electronic transmitting unit includes an electronic transmitting interface externally connected with the electrical device to charge the battery.

17. The pen-type input device of claim 14, wherein the illuminated element is disposed on the top of the main body and the illuminated button is disposed on the surface of the main body.

18. The pen-type input device of claim 14, wherein the illuminated element is a laser diode emitting light beam out of the tail end cap.

19. The pen-type input device of claim 16, wherein the electronic transmitting interface is an USB interface and transmit information of the controller to the electrical device.
